(19) United States
(12) Patent Application Publication
(10) Pub. No.: US 2025/0333174 A1
(43) Pub. Date: Oct. 30, 2025

(54) FOLDING TRAY TABLE ASSEMBLY WITH SLIDING FLAP, AND SEAT UNIT COMPRISING SUCH AN ASSEMBLY

(71) Applicant: AIRBUS ATLANTIC, ROCHEFORT (FR)

(72) Inventor: Frédéric CLOET, ROCHEFORT (FR)

(21) Appl. No.: 19/191,308

(22) Filed: Apr. 28, 2025

(30) Foreign Application Priority Data
Apr. 29, 2024 (FR) 2404471

(51) Int. Cl. B64D 11/06

(52) U.S. Cl. CPC B64D 11/0638

(57) ABSTRACT

The invention relates to a table assembly, for an aircraft seat, including a tray that can be deployed horizontally facing the seat, particularly to allow a passenger sitting in the seat to take a meal, and a locking mechanism, the table assembly including a flap sliding perpendicularly to the plane of the tray and having a closed position, wherein the tray is entirely concealed behind the flap in a storage housing, and an open position configured to release the locking mechanism and thus automatically eject the tray out of the storage housing to allow a passenger to take hold of the tray and deploy it manually. An aircraft seat unit including such a table assembly integrated into a console attached to the seat is also provided.

### CROSS REFERENCE TO RELATED APPLICATIONS

This application is based on and claims priority under 35 U.S.C. § 119 to French Patent Application No. 2404471, filed on Apr. 29, 2024, in the French Intellectual Property Office, the disclosure of which is incorporated by reference herein in its entirety.

### BACKGROUND

### Field

The present disclosure belongs to the field of aircraft cabin interior fittings, particularly deployable tray tables. It relates more particularly to a folding tray table assembly with a sliding flap, and a passenger seat unit comprising such an assembly.

The disclosure finds a direct, but non-exclusive, application in passenger seats of higher classes (business class and first class) of commercial aircraft.

### BRIEF DESCRIPTION OF RELATED DEVELOPMENTS

The deployable tray tables installed in aircraft seats date back to the very beginning of commercial aviation. This innovation has allowed passengers to benefit from a more comfortable area for taking their meals during flights. Since then, deployable tray tables have become a standard feature in many commercial aircraft.

Documents U.S. Pat. No. 10,232,946 (ergonomic table with integrated storage drawer) and U.S. Pat. No. 10,625,649 (expandable table with hinged trays) illustrate some examples of tray tables.

Historically, tray tables have been designed to be deployed from an armrest positioned along the seat, a console laterally adjacent to the seat, or from the rear of the backrest of the seat positioned just in front. In each of these configurations, it is necessary to move the table between a stowed position and a deployed position for use. Tables that can be deployed from an armrest or console require complex hinges to change the orientation of the table for storage and use, for example to switch it from vertical to horizontal. Also, tables that are deployed under a static front structure often require a linear forward and backward movement. Given that most static front structures have a different height than the ergonomic height of a tray table, complex mechanisms are required to deploy the table toward the user and lower it to the appropriate ergonomic height.

These complex mechanisms can sometimes remain visible in the seat environment, even in the stowed position of the table, which impedes the visual harmony of the seat.

Some solutions nonetheless offer simplified and lightweight mechanisms that are less visible, but without succeeding in concealing the entire table when it is in the stowed position.

This is because the tray tables of the prior art contrast visually with the overall seat design. This visual dissonance can disrupt the harmony of the cabin interior and create a visually inconsistent experience for passengers.

In addition, conventional tray tables may lack visual integration with the rest of the seat environment. Their design may not blend seamlessly with the lines and shapes of other seat elements, which can give an impression of imbalance or lack of attention to detail in the cabin design, especially in first class.

Furthermore, conventional tray tables can often be perceived as functional additions rather than integrated design elements. Their appearance can seem utilitarian and unattractive.

It should be noted here that the visually appealing aspect is an essential component in technical development programs of solutions for aircraft cabins interior fittings. The challenge is to improve the integration and ergonomics of the various equipment in a passenger seat environment, especially in higher classes.

### SUMMARY

The present disclosure aims to overcome all or part of the disadvantages of the prior art disclosed above, by providing a solution making it possible to have a folding tray table, that is fully integrated into the design of the seat environment and easy to use.

To this end, the present disclosure relates to an aircraft seat table assembly, comprising a tray that can be deployed horizontally facing the seat, in particular to allow a passenger sitting in said seat to take a meal, and an actuation mechanism allowing stowage and deployment of said tray. This table assembly is remarkable in that it comprises a flap sliding perpendicularly to the tray plane and having a closed position, wherein the tray is entirely concealed behind said flap in a storage housing, and an open position configured to release the actuation mechanism and automatically eject the tray out of said storage housing.

The sliding flap makes it possible to fold the table top away completely when it is not used, thereby contributing to a more harmonious visual appearance in the seat environment.

In addition, automatic ejection of the tray when the flap is open simplifies the process for passengers, allowing them to deploy the platform with great ease.

According to one aspect of the disclosure, the sliding flap has a shape that perfectly molds the visible shape of an element of the seat environment, for example a console adjacent to the seat.

According to an advantageous aspect of the disclosure, the sliding flap has a stable open position making it possible to reveal the tray without causing a movement of said tray, and an additional sliding of said flap beyond the stable open position allows ejection of the tray.

This provides passengers with easy access to the tray without causing involuntary movement thereof. This feature ensures a smooth and secure user experience, preventing any risk of unwanted sudden deployment of the tray. Furthermore, the additional sliding, which triggers automatic ejection of the tray, offers a user-friendly and convenient functionality for passengers.

More particularly, the additional sliding of the flap for ejection of the tray has a sliding distance less than the sliding distance between the closed position and the stable open position of said flap.

Indeed, the sliding distance required for ejection of the tray is less than that required to switch from the closed mode to the stable open position of the flap. This specificity allows easier handling of the operating mechanism of the tray.

According to one embodiment, the ejection of the tray under the effect of the opening of the sliding flap is partial, said tray remaining partially in its storage housing.

Passengers can thus easily take hold of the ejected part of the platform and pull it out completely, making the deployment process more ergonomic and controlled.

According to one embodiment, the tray is expandable and includes a base and an extension hinged on said base.

This design allows the size of the tray to be adapted to the passenger's needs, thus offering greater flexibility when using the tray table in flight.

According to one embodiment, the tray is attached to a curved support, the movement of which between a fully stored position and a fully deployed position of the tray induces a 90° rotation of said tray in its plane. This means that the tray can be stored longitudinally and extended transversely to the seat, all in the same plane.

According to one embodiment, the sliding flap includes a recess allowing a passenger to manually actuate the sliding of said flap.

According to one embodiment, the actuation mechanism comprises a locking system and an ejection spring, said locking system including a hinged lever and lock that are configured to release the tray when the flap is in the open position and thus allow the ejection spring to eject said tray.

The disclosure also relates to an aircraft passenger seat unit, comprising a seat, a console adjacent to the seat, and a table assembly as described.

According to a particularly advantageous embodiment, the table assembly is integrated into the console and blends into the shape thereof.

The fundamental concepts of the disclosure having been disclosed hereinabove in their most elementary form, other details and features will become more apparent upon reading the following description with reference to the appended drawings, giving, by way of non-limiting example, an embodiment of a folding table assembly, in accordance with the principles of the disclosure.

### BRIEF DESCRIPTION OF THE DRAWINGS

The figures are given purely by way of illustration for better understanding of the disclosure without limiting the scope thereof. The various elements may be shown schematically and are not necessarily to scale. In the set of figures, identical or equivalent elements bear the same numerical reference.

Thus, it is illustrated in:

FIG. 1: a folding tray table assembly, in a stowed position, installed in the environment of a passenger seat according to one embodiment of the disclosure;

FIG. 2: the table assembly in the fully deployed position;

FIG. 3: consecutive positions of the table assembly during automatic tray ejection;

FIG. 4: consecutive positions of the table assembly during manual deployment of the tray, occurring after the automatic ejection thereof;

FIG. 5a: a kinematic diagram of a part of the actuating mechanism of the table assembly, making it possible to hold the flap in its two stable positions: closed and open;

FIG. 5b: a kinematic diagram of another part of the actuation mechanism, making it possible to eject and lock the tray.

### DETAILED DESCRIPTION

It should be noted that certain technical elements well known to those skilled in the art are recalled herein to avoid any insufficiency or ambiguity in the understanding of the present disclosure.

In the embodiment described hereinafter, reference is made to a folding tray table assembly, essentially intended to equip a passenger seat in business class or first class of a commercial aircraft. This non-limiting example is given for a better understanding of the disclosure and does not exclude the use of the table assembly in another environment, including outside a transport vehicle.

In the context of the disclosure, the term “tray table” or simply “table” means a folding or deployable tray integrated into the seat environment, providing passengers with a stable area to take their meals, place their drinks or use electronic devices. The table can be adjusted in height, angle and depth (distance from the passenger) to suit passengers' individual preferences.

The term “seat unit” encompasses the seat and its immediate surroundings in the cabin, comprising a side console, where passengers can find equipment such as in-flight entertainment controls, power sockets, reading lights, storage for personal belongings, and more.

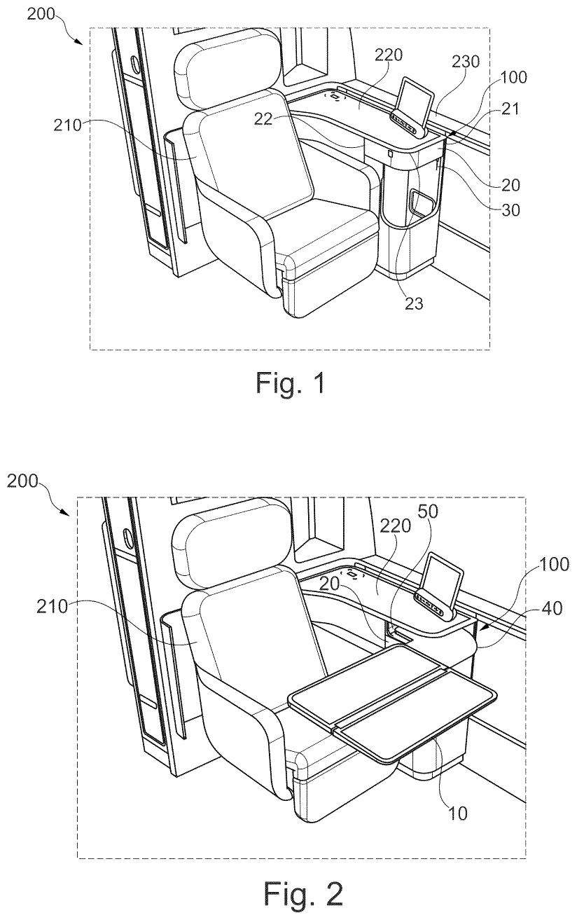

FIGS. 1 and 2 show a table assembly 100 according to one embodiment of the disclosure, equipping a seat unit 200. The seat unit 200 comprises essentially a seat 210 and a console 220 laterally attached to the seat.

According to a customary comfort level provided in higher classes (first class and business class), the seat 210 is generally convertible into a bed and the console 220 comprises various amenities intended for the passenger, although these elements are not the subject of the present disclosure.

The table assembly 100 is folding and has two end positions: a fully stored position and a fully deployed position shown in FIG. 1 and FIG. 2, respectively.

The table assembly 100 comprises a tray 10, allowing passengers to take their meal or use it for other purposes when the table assembly is in the deployed position, and a sliding flap 20 making it possible to conceal the tray 10 fully when the table assembly is in the stored position and to eject said tray automatically and partially as explained hereinafter.

When in the fully stored position, as shown in FIG. 1, the table assembly 100 blends into the shape and design of the console 220 in order to save space and above all not to alter the visual appeal of the seat unit 200.

To this end, the sliding flap 20 makes it possible to retract the tray 10 into an inner volume of the console 220 and has a geometric shape that molds the shape of said console locally.

Indeed, the sliding flap 20 has a shell shape wherein the curves follow on from the respective curves of the console 220. Thus, the sliding flap 20 appears to be an integral part of the console 220 and gives the impression of visual uniformity.

According to the exemplary embodiment illustrated, the flap 20 has an open cylindrical shape with a curved base. This curve blends into a part of the contour of the upper surface of the console 220 below which the flap 20 is located, such that in a top view, said flap is not visible below the upper surface of the console 220.

According to the same illustrated example, the flap 20 is attached onto a front part of the console 220, between its lateral face attached to the wall 230, referred to as rear face, and a central area of its lateral face attached to the seat 210, referred to as front face. Indeed, the flap 20 is mounted at the rear face of the console 220 by a first lateral side 21 and extends to its second lateral side 22 located in a central area of the front face of the console, following the outer curve defined by the upper surface of said console. This curve exhibits locally an L-shape with a rounded corner 23 in the example illustrated.

The sliding flap 20 is thus positioned to be immediately accessible to the passenger when they are properly seated on the seat 210.

The sliding flap 20 is slidably mounted in the console 220, along a longitudinal direction thereof, along a slide 30. The travel of the sliding flap 20 in its translational movement is limited and is sufficient for the deployment of the tray 10. This travel corresponds, at most, to the length of the slide 30.

Downward sliding of the flap 20 makes it possible to deploy the tray 10. The deployment of the tray 10 starts with an automatic ejection of the tray 10 caused by the opening of the flap 20 and continues manually to the fully deployed position as shown in FIG. 2.

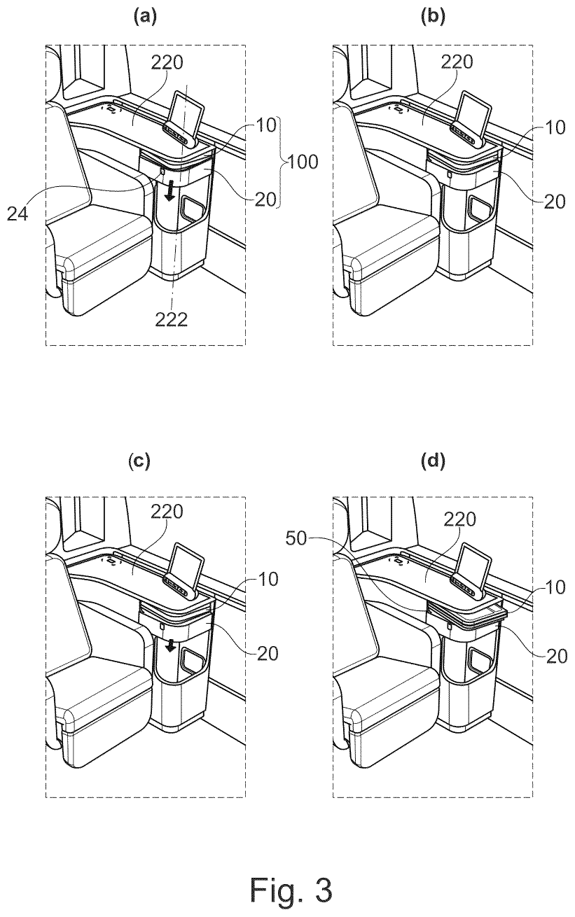

FIG. 3 shows the automatic ejection of the tray 10 with some consecutive intermediate positions.

In (a), the solid arrow pointing downward indicates the sliding direction of the flap 20 to start the deployment of the tray 10. Sliding takes place along a longitudinal direction of the console 220, represented by the axis 222. Sliding can be actuated easily by the passenger using a recess 24 allowing the passenger to have a gripping area with their fingers.

The sliding of the flap 20 continues up to a stable position shown in (b). The tray 10 is thus revealed but remains in its immobile stored position.

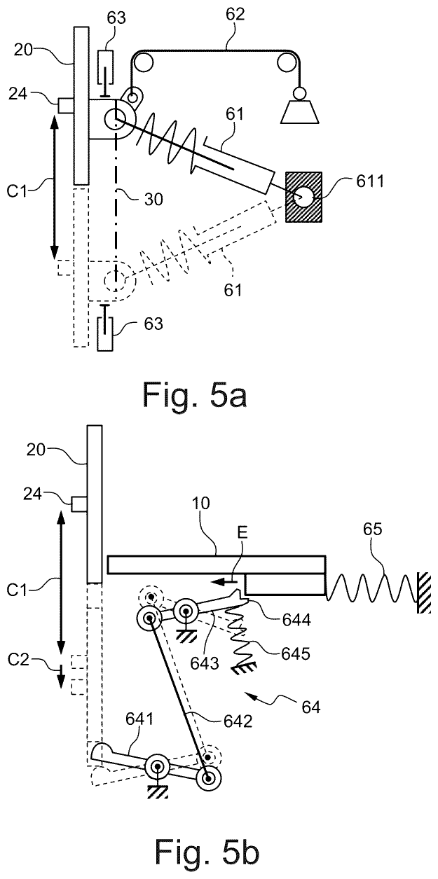

The bistable configuration of the flap 20 between the closed position and the open position is provided by an actuation mechanism which will be described with reference to FIG. 5a.

An additional downward sliding with a lower amplitude, indicated by the solid arrow in (c), makes it possible to actuate an actuation mechanism that automatically ejects the tray 10 partially out of its storage housing 50 as shown in (d).

After the additional sliding of the flap 20 which actuates the ejection of the tray 10, the flap returns to its stable position from before additional sliding, i.e. at the same height as the position shown in (b). Thus, the additional sliding for ejecting the tray 10 is a monostable sliding around an initial position which is the stable position of the open flap, and makes it possible to trigger the ejection of the tray 10 thanks to a suitable actuation mechanism which will be described hereinafter with reference to FIG. 5b.

Alternatively, the automatic partial ejection of the tray can be carried out with an ejection button, instead of the additional sliding of the flap. Such an ejection button can be positioned near the tray, preferably under the flap so as to be accessible only when the flap is open. This makes it possible to prevent untimely tray ejection more effectively.

FIG. 3 thus summarizes the automatic ejection of the tray 10 under the action of the sliding flap 20, said ejection bringing the tray 10 into an intermediate position which provides a sufficient surface area to allow a grip of the tray 10 by the passenger and continued manual deployment up to the final full deployment position.

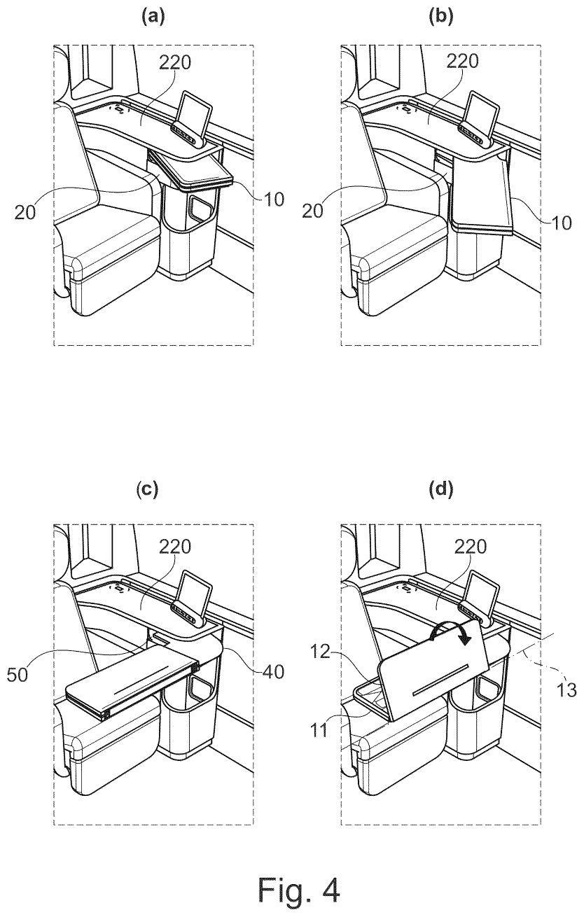

FIG. 4 shows the manual deployment of the tray 10 with some consecutive intermediate positions.

In the exemplary embodiment illustrated, the tray 10 is expandable, by being folding, and includes for this purpose two hinged parts: a base 11 and an extension 12.

The passenger starts by pulling the tray 10 towards them, in (a) and (b), until it is brought in front of them into a position of use in (c). The passenger's action induces a movement composed of translation and rotation of the tray 10 influenced by a curved support 40 which is slidably mounted along a curved line. Indeed, the tray 10 moves from a stored position wherein it is substantially parallel with the console 220 to a deployed position wherein it is substantially perpendicular to said console.

Finally, in (d), the passenger deploys the extension 12 of the tray 10 by pivoting and tilting it from the other side of the base 11, about an axis 13 acting as a junction between the two parts of said tray. The tilting of the extension 12 is indicated by the solid circular arrow.

Following this deployment of the tray 10, the table assembly 100 reaches its fully deployed position as shown in FIG. 2.

Conversely, the tray 10 is stowed by following the reverse movements of FIGS. 3 and 4 in a reverse order.

Indeed, starting from the fully deployed position of FIG. 2, the passenger starts by folding back the extension 12 of the tray 10 against the base 11, (d) to (c), then pushes the folded tray 10 into its housing 50, (b) and (a), to arrive at the configuration (d) of FIG. 3.

The configuration (d) of FIG. 3 corresponds to the ejected position of the tray 10. In this position, the passenger exerts direct pressure on the tray 10 to insert it fully into the housing 50. The tray 10 re-enters and is locked as in configuration (b) of FIG. 3.

Finally, the passenger raises the flap 20 manually up to its closed position in FIG. 1.

FIGS. 5a and 5b schematically represent, according to a particular embodiment, the actuation mechanism making it possible to produce the kinematics of the table assembly 100 as described above. Each of the two figures shows a part of this mechanism, to facilitate understanding and avoid a single figure that would be unreadable with the entire mechanism shown. Thus, to reconstitute the actuation mechanism in its entirety, it is simply necessary to superimpose FIGS. 5a and 5b.

Furthermore, each part of the mechanism shown in one of FIG. 5a or 5b fulfills a specific and well-defined function.

FIG. 5a shows the part of the mechanism responsible for the bistable position of the sliding flap 20 between the closed position (at the top) and the open position (at the bottom, broken line).

To this end, the actuating mechanism comprises a spring holding system 61, making it possible to hold the flap 20 stably either in the closed position or in the open position. The holding system 61 is hinged between the rear of the flap 20, that is movable, and a fixed axis 611.

The actuating mechanism also comprises a weight compensator 62 for assisting the sliding movement C1 of the flap 20 for a better sensation when handling said sliding flap, and end-of-travel buffers 63 with “soft” stops for soft and non-slam opening and closing.

The sliding movement between the two stable positions of the flap 20, represented by the double arrow C1, makes it possible simply to open or close the storage space of the tray 10 without ejecting it.

FIG. 5b shows the part of the mechanism responsible for ejecting the tray 10 and locking it in the stored position.

After the first sliding C1 making it possible to move the flap 20 from its closed position to its stable open position, a second downward sliding C2 makes it possible to eject the tray 10 as described above.

To this end, the actuation mechanism comprises a locking system 64 including an actuation lever 641 and a lock 643 hinged, end-to-end, by a rod 642. The lever 641 and the lock 643 are also hinged, each, on a fixed central axis. Thus, when the user applies the additional sliding C2, the flap 20 presses on the free end of the lever 641 which then tilts about its fixed hinge axis. This movement is then transferred to the lock 643 via the rod 642, said lock also tilts in an opposite direction to release the tray 10, initially retained by the free end 644 of the lock 643.

The actuating mechanism also comprises a spring 65 which ejects E the tray 10 when the latter is released from the lock 643.

When the tray 10 is ejected, the lock 643 remains locked in its open position, shown as a dotted line, constraining a return spring 645.

Conversely, the pressure exerted to return the plate 10 to its storage position causes it to retract until the return spring 645 can push the lock 643 into its closed position to lock the position of the tray 10 again.

If the additional sliding C2 of the flap is replaced by an ejection button, the latter can be connected to an ejection and locking mechanism similar to or identical to that described in FIG. 5b, with a few common adaptations.

The disclosure as described relates to a tray table assembly integrated into the environment of a passenger seat in an aircraft. This assembly is designed to provide passengers with a stable area for taking their meals, placing their drinks or using electronic devices. The tray table is folding and has two positions: stored and deployed. In the stored position, it blends into the design of the side console, saving space in the cabin and preserving its visual appearance. When the table is deployed, it provides a folding tray with a base and an extension, suitable for various uses. The extension of the table is initiated by opening a sliding flap and can be carried out easily by the passenger. Once deployed, the table provides a comfortable area for passengers, thus enhancing their in-flight experience. Finally, the table is stowed by performing the reverse procedure to deployment, providing visual integration in the environment of the passenger seat.

What is claimed is:

1. A table assembly, for an aircraft seat, comprising a tray that can be deployed horizontally facing the seat, in particular to allow a passenger sitting in said seat to take a meal, and an actuation mechanism, said table assembly being characterized in that it comprises a flap sliding perpendicularly to the plane of the tray and having a closed position, wherein the tray is entirely concealed behind said flap in a storage housing, and an open position configured to release the actuation mechanism and automatically eject the tray out of said storage housing.

2. The table assembly according to claim 1, wherein the sliding flap has a stable open position making it possible to reveal the tray without causing a movement of said tray, and wherein an additional sliding of said flap beyond the stable open position allows ejection of the tray.

3. The table assembly according to claim 2, wherein the additional sliding of the flap for ejection of the tray has a sliding distance less than the sliding distance between the closed position and the stable open position of said flap.

4. The table assembly according to claim 1, wherein the ejection of the tray under the effect of the opening of the sliding flap is partial, said tray remaining partially in its storage housing.

5. The table assembly according to claim 1, wherein the tray is expandable and includes a base and an extension hinged on said base.

6. The table assembly according to claim 1, wherein the tray is attached to a curved support, the movement of which between a fully stored position and a fully deployed position of the tray induces a 90° rotation of said tray in its plane.

7. The table assembly according to claim 1, wherein the sliding flap includes a recess allowing a passenger to manually actuate the sliding of said flap.

8. The table assembly according to claim 1, wherein the actuation mechanism comprises a locking system and an ejection spring, said locking system including a hinged lever and lock that are configured to release the tray when the flap is in the open position and thus allow the ejection spring to eject said tray.

9. An aircraft passenger seat unit, comprising a seat and a console adjacent to the seat, characterized in that it comprises a table assembly according to claim 1.

10. The seat unit according to claim 9, wherein the table assembly is integrated into the console and blends into its shape.
